(19) United States
(12) Patent Application Publication
(10) Pub. No.: US 2008/0281960 A1
(43) Pub. Date: Nov. 13, 2008

(54) Traffic supervision system

(75) Inventor: Thord Schibler, Stockholm (SE)

Correspondence Address: BINGHAM MCCUTCHEN LLP, 2020 K Street, N.W., Intellectual Property Department, WASHINGTON, DC, 20006, US

(73) Assignee: ORACLE INTERNATIONAL CORPORATION

(21) Appl. No.: 11/892,524

(22) Filed: Aug. 23, 2007

(30) Foreign Application Priority Data
May 11, 2007 (SE) 0701143-0

(51) Int. Cl. G06F 15/16

(52) U.S. Cl. 709/224

(57) ABSTRACT

A method and a computer system for monitoring traffic, the computer system comprising an information handling server (7) arranged to receive through a communications network (5) location data transmitted from at least a first and a second reporting means (3) in at least a first (1) and a second (2) vehicle, respectively, at least a first database (13) for storing said location data, an analysis server (15) arranged to retrieve said location data from the first database (13), analyze said location data and store data regarding the result of the analysis and/or present the result of the analysis to an operator and/or a monitoring function. The information handling server (7) and the client preferably support the Session Initiation Protocol, SIP.

### TECHNICAL FIELD

The present invention relates to a traffic supervision system.

### BACKGROUND AND RELATED ART

For traffic supervision several methods exist in the prior art, for example, to provide input data for traffic planning. The simplest, from a technical point of view, is to observe the traffic and manually count the cars passing on a specific road or crossroads during a certain period of time. Alternatively, a ribbon that is arranged to register the passing of a car man be placed across the road, connected to an electronic counter, for a specific period of time.

These solutions are generally limited to providing data about the number of vehicles that pass a particular point during a certain period of time.

A solution that may provide slightly more sophisticated data is to monitor the traffic from the air, for example, from a helicopter. A video camera can be used to record the traffic, which can then be analyzed. This is still limited to watching a limited area at any given time. Hence, there is no way of finding out how the cars move, for example, where the cars in the area come from or are going to, or what is the preferred route between two geographical locations.

OnStar is a communications, monitoring and tracking service provided by General Motors. This system enables a driver of a vehicle to contact emergency services through an existing mobile telecommunications network. The user initiates gathering of vehicle data and GPS location and transmission of such data to an OnStar centre, by pressing a button. The system also provides other functions, such as enabling a user to search for information on the Internet.

### SUMMARY OF THE INVENTION

One aspect of the present invention relates to a computer system comprising an information handling server arranged to receive through a communications network location data transmitted from at least a first and a second reporting means in at least a first and a second vehicle, respectively, at least a first database for storing said location data, an analysis server arranged to retrieve said location data from the first database, analyze said location data and store data regarding the result of the analysis and/or present the result of the analysis to an operator and/or a monitoring function.

Another aspect of the invention relates to a computer client for use in a vehicle arranged to receive positioning information from a positioning means for monitoring the vehicle's position, said computer client comprising communication means arranged to communicate location data received from the positioning means through a communications network to an information handling server.

A further aspect of the invention relates to a method for use in a computer client located in a vehicle, said method comprising the steps of

Registering the client with an information handling server through a communications network at the beginning of a journey with the vehicle,

Sending position data from the client to the information handling server repeatedly, said position data comprising information about the vehicle's position and speed,

Deregistering the client when the journey is over.

An aspect of the invention also relates to a method for use in a computer system including an information handling server and a database, the method comprising the steps of

Receiving said information handling server information from a number of computer clients each located in a vehicle regarding the client's position and speed,

Storing the information in the database,

Analyzing, by an analysis server information stored in the database,

Presenting the result of the analysis to an operator.

The invention thus provides a system for more sophisticated traffic monitoring than that enabled in the prior art.

The system and method according to the invention enable the gathering of traffic information in real time, and the processing of such information for a number of different purposes, including statistics which can be used, for example, in infrastructure planning. It may also be used for identifying traffic jams or risk of traffic jams, and/or places in which accidents are likely to occur.

The vehicles may be tracked on an individual basis for a period of time, which makes it possible to determine, for example, the route or routes most often taken when travelling between two specific geographical locations.

If an identifier is included with the location information sent to the system the invention may be used for monitoring the location of specific vehicles, for example, buses or emergency vehicles such as police cars, fire engines or ambulances. This information may be used for supervising emergency actions.

Users of the system can also be informed about the location of other vehicles. For example, users waiting for a bus can be informed about the specific location and/or expected time of arrival of the bus. Users travelling along a road in front of an emergency vehicle can also be warned that an emergency vehicle is approaching and that they should make way for this vehicle.

In a preferred embodiment the client and server of the invention are able to communicate using the Session Initiation Protocol (SIP), as defined, for example, in RFC 3261 and its subsequent references. According to one embodiment the analysis server comprises at least one SIP servlet.

The analysis server preferably comprises means for statistical analysis of the data. This will enable the gathering of traffic pattern information, for example about bottlenecks during rush hours, areas often affected by traffic jams or accidents or other relevant information which may be used when planning new or improved roads or as background information when directing or redirecting traffic.

The computer system preferably further comprises a result data base for storing analysis results received from the analysis server.

The first database may be duplicated in a second database which is a copy of the first database taken at a specific time. In this case the analysis server may be arranged to retrieve said location data from the second database so that data can be written to the first database without disturbance.

The communication means in the client may be arranged to communicate said location data to the information handling server at regular time intervals or the communication may be triggered by certain events, such as the vehicle turning onto a new road. A combination of regular intervals and certain events may also be used.

The positioning means is preferably a positioning means for use with the global positioning system, GPS, and may be integrated in the client or external to the client.

### BRIEF DESCRIPTION OF THE DRAWINGS

The invention will be described in more detail in the following, by way of example and with reference to the appended drawings in which:

FIG. 1 is a general overview of a system according to a general embodiment of the invention,

FIG. 2 shows an example embodiment of the equipment on the server side of a system according to an embodiment of the invention,

FIG. 3 is a flow chart of the method performed by the computer client, and

FIG. 4 is a flow chart of the method performed by the server for traffic surveillance.

FIG. 5 is a flow chart of the method performed by the server for statistical analysis.

### DETAILED DESCRIPTION OF EMBODIMENTS

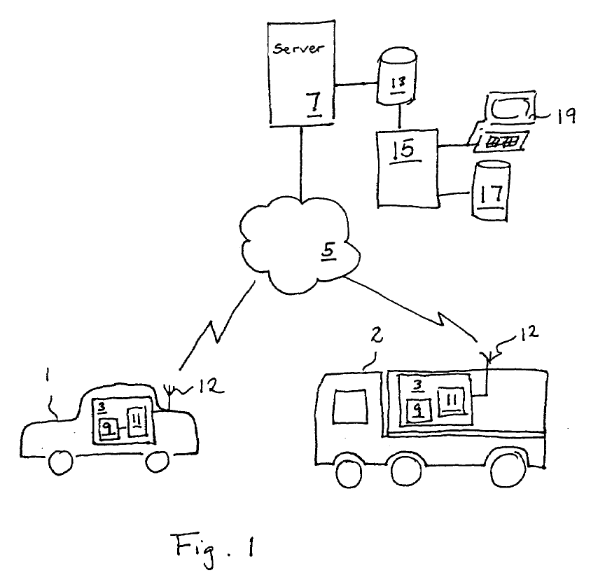

FIG. 1 shows a first 1 and a second 2 vehicle, each comprising reporting means 3 for communicating its position through a network 5 to an information handling server 7. The reporting means 3 comprises, or connected to, a positioning means 9, such as a GPS or other unit that is able to detect and report the vehicle's position. The reporting means 3 also comprises communication means 11 arranged for wireless connection to the network 5 for reporting the position detected by the positioning means 9 through the network 5 to the information handling server 7. The communication means 11 is shown schematically connected to an antenna 12 providing wireless connection to the network 5. The antenna may be internal to the reporting means or an antenna mounted on the vehicle. Preferably, the reporting means 3 also comprises input means and a display and/or other user interface for displaying information to the driver of the vehicle, as will be discussed in more detail in the following. The network 5, which is shown merely as a cloud can be any communications network that allows wireless access, for example a Wireless LAN (WLAN), GSM, 3G or other cellular network, or an Internet, or a combination of two or more networks communicating with each other.

In a preferred embodiment the reporting communication means 11 is a SIP client, or another type of client supporting SIP and possibly other protocols. In this case, the information handling server 7 is a SIP application server, or other server supporting SIP, that is, arranged to receive presence messages from SIP clients and possibly other types of clients. In a SIP environment each vehicle that is equipped with a SIP client can make its position available to the SIP application server through a REGISTER, then a SUBSCRIBE and finally a position PUBLISH. The SIP client can then receive updates by means of the NOTIFY or MESSAGE functions defined in the SIP protocol. The SIP functions also include INVITE, which enables IP telephone calls for example to the members of the buddy list.

The client may be comprised in a personal digital assistant (PDA) or a mobile telephone or other type of mobile terminal such as a smartphone including or associated with a GPS unit and arranged to perform all communication with the server 7.

The information handling server 7 may be connected to the network 5 through a wired or wireless connection. Preferably the information handling server 7 merely receives data from the reporting means of the vehicles and stores these data in a first database 13. The data received from the reporting means comprises position data for the vehicle. Preferably it also comprises identity data for the vehicle or the driver of the vehicle. This will make it possible to store data more efficiently. Subsequent bits of data from the same vehicle make it possible to determine the direction of the vehicle. If data is received from the same vehicle sufficiently often, the speed of the vehicle can also be determined. Communication of identity data will also make it possible to communicate data to the user, for example, about the traffic situation ahead. On the other hand, such a function may be perceived to violate the user's integrity, since it enables monitoring his/her movement in a very detailed way. For some types of vehicles such monitoring may provide an important function in that it may always be known where the vehicle is located. For example, for school buses or other types of commercial traffic this may offer valuable information regarding the location of the bus, the route travelled, the number of people on the bus, or getting on or off at a particular stop. This location information may be used for remote control of certain vehicles, for example, to force a school bus or a high-risk transport that has been hijacked to stop by turning off the engine.

For emergency vehicles, such as police cars, fire engines or ambulances, the inventive system may provide a means for monitoring their location and for planning the best route to the destination. The best route may be the fastest route, but it may also be determined according to some other criterion. For example if a traffic jam has occurred the situation may be evaluated or analyzed for planning the best route for an emergency vehicle, which may be instructed to go against the traffic on a one-way street to bypass the traffic jam and get ahead. Hence, for some vehicles special rules may apply in order to select the best or fastest route. Also, vehicles located in the route ahead of the emergency vehicle may be warned through the inventive system that they should make way for an approaching emergency vehicle.

An analysis server 15 is arranged to retrieve data from the first data base 13, and analyze them. The result of the analysis may be stored in a result data base 17 and/or displayed on a user interface which may comprise a display 19, such as a computer screen, and/or means for alerting an operator, such as lights and/or that are arranged to flash and/or set of an audio alarm in the case of a high risk situation. The user interface preferably also comprises user input means such as a menu system, a pointer device (mouse) and/or a keyboard. In a SIP environment the analysis server 15 may comprise one or more SIP servlets. The nature of the analysis will be discussed in more detail below.

The analysis server 15 is connected to a database containing geographical map information, which may be used, together with the position data received from the vehicles, to analyze the traffic situation. For example, information about the size and capacity of a road in conjunction with the number of cars present on this road, or on a particular section of the road, may be used to determine the risk of traffic jam. If a number of cars in the same area stand still or move very slowly this, too may indicate a traffic jam. For example, all cars located between two particular exits on a road may be considered, or all cars approaching a crossroads on any of the roads leading to the crossroads.

This information may also be used for remote control of traffic lights based on the current traffic situation, for example during busy periods. If the reporting means used by the vehicles also report their address, or identity in the network, the information can also be sent to the reporting means of vehicles that are or may be affected by the traffic situation. In a SIP environment this would be achieved by the users subscribing to traffic news regarding congestions, accidents, road work in progress, and other situations affecting the traffic. For example, drivers may be advised to choose a different route, or to drive carefully to avoid causing accidents if the traffic is slow or jammed. An alternative route may be presented, from the analysis server 15 through the network. Alternatively, it may be determined by the internal positioning means 9 of the vehicle based on data from the analysis server 15 regarding situations affecting the traffic. In either case it may be presented to the driver as audio data, or on a display comprised in the reporting means 3.

The reporting means 3 may also comprise other information, for example, one or more electronic maps comprising information about the location of, for example, gas stations, possibly from a specific chain, malls, restaurants, hotels or other locations that may be of interest to the driver, such as pharmacies, hospitals or museums or other sights of particular interest. The reporting means 3 may also be connected to the monitoring function for mileage and fuel usage in the vehicle, so that the driver can be alerted, and information about the nearest gas station of the desired chain can be displayed when more fuel is needed. Information about gas stations, etc. may also be found in a server in the network. In this case, the relevant information for a particular vehicle is selected based on location data received from this vehicle and transmitted to the vehicle.

The reporting means may also be used for other functions. In particular it will be suitable for functions that are dependent on the location of the vehicle, such as payment of parking fees, or payment of car tolls. This could be achieved using a SIP client by generating a simple message.

A web interface may be provided in the reporting means 3, and/or in the display 19 to enable monitoring of vehicles. This may be used, for example, by commercial vehicles such as a road carrier company to keep track of the cars, ensure that sufficient stops are made according to security regulations, etc. Such a monitoring function may also be of use for other types of businesses, such as taxi, delivery, retail, moving, or for emergency vehicles such as police cars or ambulances. A route can be planned centrally in a computer and transmitted to the driver of the commercial vehicle. It may also enable a user to seek the location of a driver on this user's buddy list.

How often location information should be transmitted may depend on a number of factors. In the simplest case all vehicles report their location with a predefined frequency, for example, once every 30 or 60 seconds. Alternatively, the reporting means may comprise logic enabling it to vary the frequency. In this case, the frequency may be adapted to the situation, so that if the vehicle is moving fast the information is transmitted more often. Alternatively, or in addition to this, the reporting means may be arranged to report its location each time the vehicle changes direction, to avoid any doubt regarding, for example, if a left or right turn was made at a crossroads. As a directional sensing means, a gyro arranged to sense acceleration may be mounted on the vehicle in order to sense a change of direction. Alternatively, information about a left or right turn may be derived from the location data of the positioning means 9.

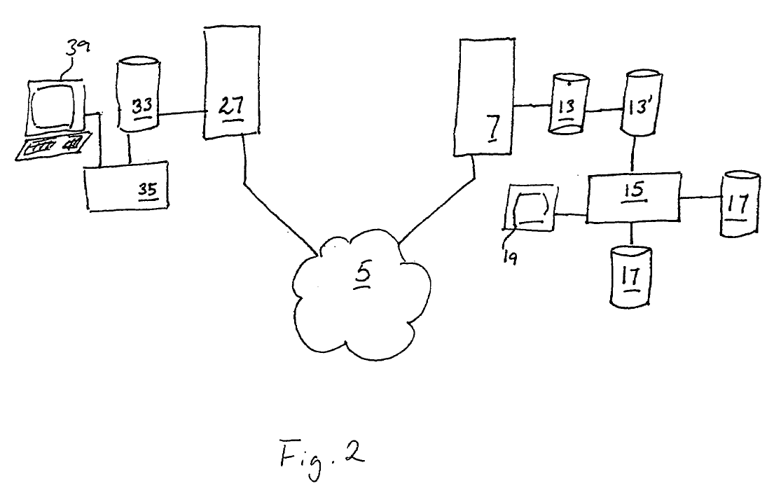

FIG. 2 illustrates an embodiment of the server side of the invention, that is, the vehicles and their communication with the network 5 is not shown in this Figure. As before, an information handling server 7 is connected to the network 5 through a wired or wireless connection. The information handling server receives position data from the vehicles through the network and forwards it to a first database 13. In FIG. 2, the first database 13 is duplicated in that a second database 13′ is provided, which is a copy of the first database 13, taken at a specific time, preferably at regular intervals. In this way, the analysis server 15 can retrieve data for analysis from the second database 13′ while the information handling server 7 is writing data to the first database 13, without the retrieving and writing functions disturbing each other.

In this case, the analysis server 15 is connected to two result databases 17, but of course one or several result databases 17 may be used as well, for storing, for example, different types of analysis results, and/or results pertaining to different geographical areas. A display unit 19 for communicating analysis results to an operator is also provided. There may be a number of display units 19 for presenting various specific areas, for example, one for each of the city centre, the north junction, the east junction, etc. Also there may be display units specifically arranged to show the location of special traffic such as emergency vehicles or high-risk vehicles, for example transporting fuel or other dangerous goods.

Shown in FIG. 2 is a second information handling server 27 and an information database 13 which perform essentially the same types of functions as the information handling server 7 and the first database 13. The information database 33 may be duplicated in the same way as the first database 13, although this is not shown in FIG. 2.

The information database is connected to a second analysis server 35, which is arranged to analyze the data stored in the information database 33. The analysis result may be stored in one or more result databases (not shown) and/or communicated to an operator through user input/output means 39, which may be any of the user input/output means discussed above.

The second information handling server 27 may be used for monitoring only a specific subset of the traffic, for example, in a particular area of interest. Preferably, however, the second information handling server 27 is used to monitor a specific type of traffic, for example, related to emergency vehicles. In this case, only messages comprising a specific identifier indicating that the message originates from an emergency vehicle are registered by the second information handling server 27 and stored in the information database 33. This ensures a sufficient storage and analysis capacity for information relating to the desired subset of traffic.

Of course, the configuration discussed in connection with the databases 13, 13′ and 17 may be used even if no second information handling server is present in the system. Similarly, the second information handling server 27 and the database 33 and analysis server 35 associated with it, used for a specific subset of traffic, may be present without the first information handling server 7 and the databases and analysis server associated with it. Of course, several information handling servers may be connected to the network 5, each having its own information database, and analysis server.

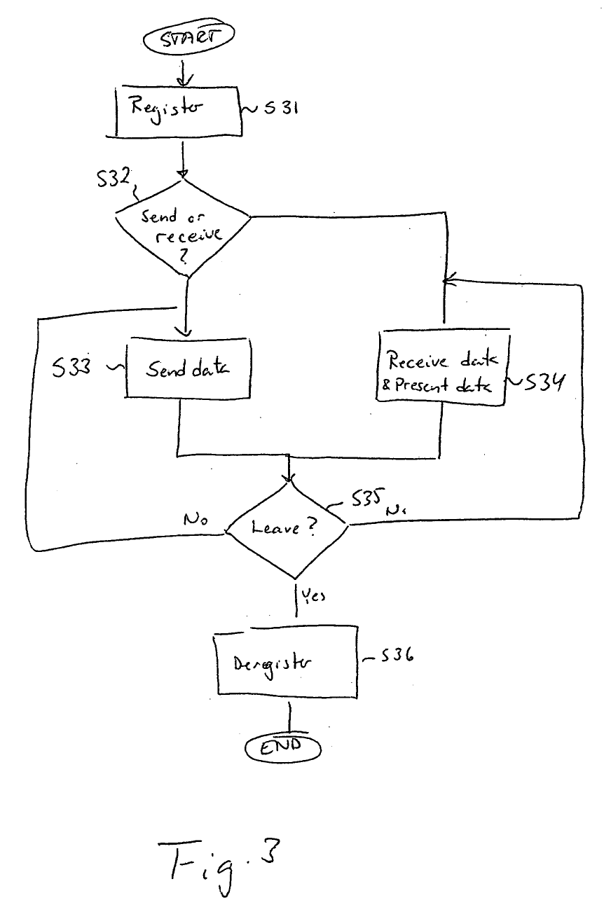

FIG. 3 is a flow chart of the method performed by the client located in a vehicle.

In step S31, when the vehicle is started, the client 3 registers with the information handling server 7. The registration may be automatic, for example, upon starting the engine, or may be performed manually by the user. This involves sending initial data to the server 7, which may include the vehicle's identity, the intended destination, and any services that the driver wants to subscribe to.

Step S32 is a decision box to determine if the client is to send or receive data. To send data, go to step S33; to receive data, go to step S34.

In step S33 the client sends data, primarily position data, to the server 7. As discussed above, this step is repeated either at regular intervals, or triggered by certain events, for example, when the car changes directions. Go to step S35.

In step S34 the client receives data from the server 7, or from another unit in the network. The data may include information about the traffic situation ahead of the vehicle, for example, if there has been an accident, if there is a traffic jam, or anything else that should influence, for example, the speed, or lead the driver to change the planned route. The information is presented to the driver in a suitable way, for example audibly, or on a display. This step is repeated as often as is adequate, that is, whenever data is sent to the client during the journey. Go to step S35.

In step S35 it is decided whether the vehicle should leave the system, usually when the journey is over and the vehicle has reached its destination. If yes, go to step S36; if no, return to step S33 and/or S34.

In step S36 the journey is over and the client leaves the system. This may be done automatically when the engine is turned off, or may be performed manually by the driver.

As will be understood data may be sent and received at the same time, that is, steps S33 and S34 can be performed in parallel. The position data sent in step S33 may be obtained, for example, from a GPS unit, which may be a part of the client or an external device arranged to provide data to the client.

As discussed above, it is possible to let only some clients, for example, clients in special types of vehicles (for example buses, emergency vehicles and/or taxis) identify themselves in such a way as to enable the transmission of information to the clients. Other clients may still keep their anonymity in the sense that they are only identified to the extent needed to monitor their movements, not by means of any address or actual identity of the client or vehicle.

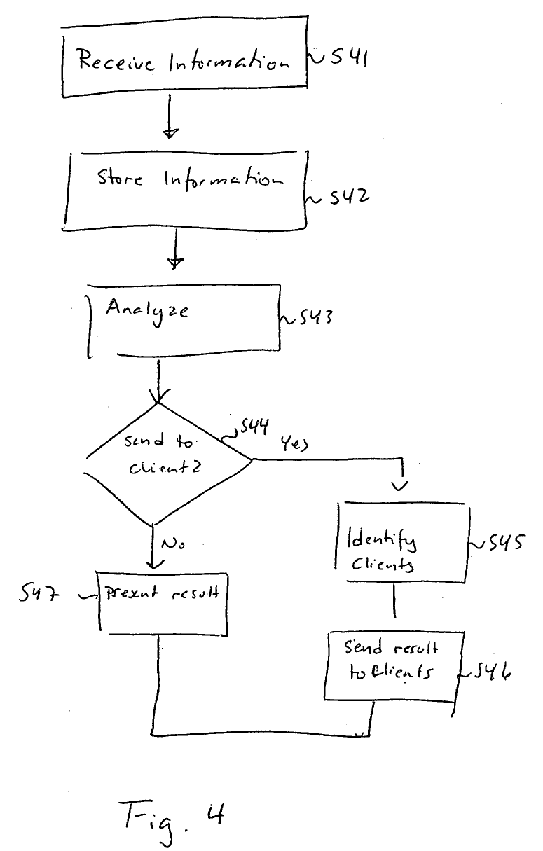

FIG. 4 is a flow chart of the surveillance procedure performed by the computer system including the information handling server 7 in the network.

In step S41 information is received from a number of vehicles and in step S42 the information is stored in the database 13. As discussed in connection with FIG. 2, the database 13 may be duplicated.

In step S43 the data is analyzed in the analysis server 15. The analysis is directed to identifying the instantaneous traffic situation. Hence, only data from a relatively short period of time preceding the time of the analysis is used. The analysis may include, for all roads, or for some roads that have been identified as particularly important, the number of cars present in a particular interval of the road, the speed with which the cars are moving, any reported problems such as jam or accidents.

Step S44 is a decision step to determine if information about the traffic situation should be sent to any vehicles. Preferably only vehicles that are likely to be affected by the situation should receive information.

In step S45 any clients located in vehicles that are concerned by an identified problem, such as a traffic jam, an unusually low speed, or an accident are identified. In identifying the clients information about the client identity provided by the client in step S31 may be used. Further, information provided by the client about the vehicle's location and speed is preferably used to determine where the vehicle will be in the near future. In addition information about the intended destination of the vehicle, if provided in step S31, may be used to predict the route that the vehicle may take and hence which incidents may affect the vehicle in the future.

In step S46 the clients identified in step S45 are informed about the problem and possible advised to take precautions. The precautions may be, for example, to choose another route, or to slow down to avoid a crash.

In step S47 the result of the analysis performed in step S43 is presented to one or more operators or supervisors. The way of presenting the result may depend on the result. If no abnormal situation is identified the result may simply be presented on a screen, in any suitable form. If an emergency situation is identified this may cause an audible alarm to be issued and the information may be presented on the screen in such a way as to attract special attention. The analysis result may also be used to direct emergency vehicles to the right place and to find the optimal route for them. The branch consisting of steps S45 and S46 and the branch consisting of step S47 are preferably performed in parallel, so that both the vehicles concerned and one or more central operators or supervisors can be informed about the traffic situation at the same time.

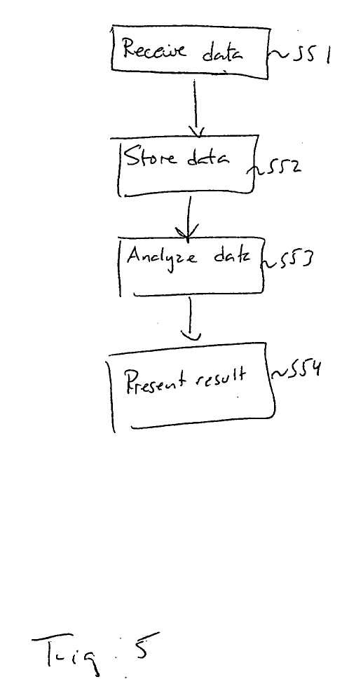

FIG. 5 is a flow chart illustrating a method for statistical analysis of data. In step S51 data is received in the information handling server 7 from a number of clients 3 located in vehicles 1, 2. Data is stored in the database 13 in step S52.

In step S53 the data is analyzed and in step S54 the analysis results are presented. The analysis involves analysis of data from a longer period of time, for example, weeks, months, or even years. Traffic patterns for example during rush hours or on public holidays may be established, to identify bottlenecks. For example, the traffic pattern on Monday mornings, or on the days before Christmas may be analyzed to predict future traffic patterns on such days. The analysis result may be used, for example, to determine the need for new or improved roads, and/or issue recommendations to the public about which times and/or areas to avoid.

Trends such as increasing or decreasing traffic on certain roads or during certain times may be established. The results may be presented as figures, and/or various types of diagrams, to facilitate the interpretation of the data.

In order to protect the integrity of the vehicle or driver the client may execute off line while driving and then send all data related to a journey to the server at once, for example at the end of the day, or week, or when the journey is over. This will provide statistical data to the server that can be analyzed, while the client will not be monitored in real time. The data can of course be transmitted anonymously for increased integrity or, alternatively, with identification of the driver and/or vehicle.

1. A computer system comprising an information handling server arranged to receive through a communications network location data transmitted from at least a first and a second reporting means in at least a first and a second vehicle, respectively, at least a first database for storing said location data, an analysis server arranged to retrieve said location data from the first database, analyze said location data and store data regarding the result of the analysis and/or present the result of the analysis to an operator and/or a monitoring function.

2. A computer system according to claim 1, wherein the information handling server is an application server supporting the Session Initiation Protocol, SIP.

3. A computer system according to claim 1, wherein the analysis server comprises at least one SIP servlet.

4. A computer system according to claim 1, wherein the analysis server comprises means for statistical analysis of the data.

5. A computer system according to claim 1, further comprising a result data base for storing analysis results received from the analysis server.

6. A computer system according to claim 1, further comprising a second database which is a copy of the first database taken at a specific time, wherein the analysis server is arranged to retrieve said location data from the second database.

7. A computer client for use in a vehicle arranged to receive positioning information from a positioning means for monitoring the vehicle's position, said computer client comprising communication means arranged to communicate location data received from the positioning means through a communications network to an information handling server.

8. A computer client according to claim 7, wherein the positioning means is comprised in the computer client.

9. A computer client according to claim 7, wherein the communication means is arranged to communicate said location data to the information handling server at regular time intervals.

10. A computer client according to claim 7, wherein the communication means is arranged to communicate said location data to the information handling server when the vehicle changes direction.

11. A computer client according to claim 7, further comprising means for receiving from at least one directional sensing means, information about a change of direction of the vehicle.

12. A computer client according to claim 7, wherein the positioning means is a positioning means for use with the global positioning system, GPS.

13. A computer client according to claim 7, said client being capable of communicating according to the Session Initiation Protocol, SIP.

14. A communications system for monitoring traffic data, comprising at least one computer system comprising an information handling server arranged to receive through a communications network location data transmitted from at least a first and a second reporting means in at least a first and a second vehicle, respectively, at least a first database for storing said location data, an analysis server arranged to retrieve said location data from the first database, analyze said location data and store data regarding the result of the analysis and/or present the result of the analysis to an operator and/or a monitoring function, said computer system being arranged to communicate with a plurality of computer clients through a communications network, each computer client arranged for use in a vehicle arranged to receive positioning information from a positioning means for monitoring the vehicle's position, and comprising communication means arranged to communicate location data received from the positioning means through a communications network to an information handling server.

15. A method for use in a computer client located in a vehicle, said method comprising the steps of
Registering the client with an information handling server through a communications network at the beginning of a journey with the vehicle,
Sending position data from the client to the information handling server repeatedly, said position data comprising information about the vehicle's position and speed,
Deregistering the client when the journey is over.

16. A method according to claim 15, wherein the registration is performed automatically, upon starting the engine.

17. A method according to claim 15, wherein the registration includes sending data about the vehicle's identity, the intended destination, and any services that the driver wants to subscribe to the information handling server.

18. A method according to claim 15, wherein the step of sending data to the information handling server is repeated either at regular intervals.

19. A method according to claim 15, wherein the step of sending data to the information handling server is triggered by certain events, for example, when the car changes directions.

20. A method according to claim 15, further comprising the step of receiving data from the information handling server, said data including information about the traffic situation ahead of the vehicle.

21. A method for use in a computer system including an information handling server and a database, the method comprising the steps of
Receiving said information handling server information from a number of computer clients each located in a vehicle regarding the client's position and speed,
Storing the information in the database,
Analyzing, by an analysis server information stored in the database,
Presenting the result of the analysis to an operator.

22. A method according to claim 21, wherein the analysis involves analysis of recent data to identify the current traffic situation.

23. A method according to claim 21 comprising the step of identifying any abnormal situations and issuing an alarm in the case of an emergency.

24. A method according to claim 21 comprising the step of identifying at least one of the clients, identifying information related to the analysis result that may affect the at least one client and sending the identified information to the at least one client.

25. A method according to claim 21, wherein the analysis involves statistical analysis of data gathered over a period of time.
